(19) United States
(12) Patent Application Publication
(10) Pub. No.: US 2017/0285242 A1
(43) Pub. Date: Oct. 5, 2017

(54) LIQUID CRYSTAL DISPLAY DEVICE

(71) Applicant: Panasonic Liquid Crystal Display Co., Ltd., Himeji-Shi (JP)

(72) Inventors: Naoki SATO, Hyogo (JP); Ryosuke YABUKI, Hyogo (JP)

(21) Appl. No.: 15/473,057

(22) Filed: Mar. 29, 2017

(30) Foreign Application Priority Data
Mar. 30, 2016 (JP) 2016-069508

(51) Int. Cl. F21V 8/00

(52) U.S. Cl. CPC G02B 6/0028; G02B 6/0026; G02B 6/003; G02B 6/0031

(57) ABSTRACT

A liquid crystal display device includes a light source that emits light having a predetermined color; a lens that concentrates the light emitted from the light source and causes the light to exit; a band-pass filter that transmits specific-band light having a specific-band wavelength in the light exiting from the lens; and a light guide plate disposed on a rear surface side of a display panel. The specific-band light transmitted through the band-pass filter is incident on a lateral surface of the light guide plate.

### CROSS-REFERENCE TO RELATED APPLICATION

The present application claims priority from Japanese application JP 2016-069508 filed on Mar. 30, 2016, the content of which is hereby incorporated by reference into this application.

### TECHNICAL FIELD

This disclosure relates to a liquid crystal display device.

### BACKGROUND

A light emitting diode (LED) constituting a light source for a backlight in the liquid crystal display device has low color reproducibility because of its broad spectral characteristic. A prior art discloses use of a band-pass filter (BPF) that transmits light having a specific-band wavelength in order to improve the color reproducibility of the liquid crystal display device. Because the band-pass filter has an incident angle dependency, in order to effectively transmit the light having the specific-band wavelength, the light is preferably vertically incident on the band-pass filter. In the prior art, in order to increase a component of the light vertically incident on the band-pass filter, the light emitted from the light source is vertically incident on the band-pass filter after the light is concentrated with a prism (See Japanese unexamined published patent application No. 2003-337334).

Nowadays, there is a demand for further improving the color reproducibility of the liquid crystal display device. In the light concentration with the prism described in the above prior art, a transmission effect of the band-pass filter is insufficiently obtained, and the desired color reproducibility cannot be provided. It is difficult to prepare a large-area band-pass filter corresponding to a large-size liquid crystal display device, and the conventional technique cannot deal with an increase in size of the liquid crystal display device.

### SUMMARY

The present disclosure has been made in view of the above problems, and an object thereof is to improve color reproducibility in a liquid crystal display device.

In one general aspect, the instant application describes a liquid crystal display device including a light source that emits light having a predetermined color, a lens that concentrates the light emitted from the light source and causes the light to exit, a band-pass filter that transmits specific-band light having a specific-band wavelength in the light exiting from the lens, and a light guide plate disposed on a rear surface side of a display panel. The specific-band light transmitted through the band-pass filter is incident on a lateral surface of the light guide plate.

The above general aspect may include one or more of the following features. The light source, the lens, and the band-pass filter may be disposed on a lateral surface side of the light guide plate. The liquid crystal display device may further include a sub-light guide plate disposed between the band-pass filter and the light guide plate. In the sub-light guide plate, a height in a first direction, which is a thickness direction of the light guide plate, at a light exiting port through which the light exits to the light guide plate may be smaller than a height in the first direction at a light incident port through which the light is incident from the band-pass filter.

The light source, the lens, and the band-pass filter may be disposed on a rear surface side of the light guide plate. The liquid crystal display device may further include a sub-light guide plate that guides the specific-band light transmitted through the band-pass filter to the light guide plate. The sub-light guide plate may include a first portion located on a lateral surface side of the light guide plate and a second portion that is connected to the first portion and located on the rear surface side of the light guide plate.

In the sub-light guide plate, a height in a first direction, which is a thickness direction of the light guide plate, at a light exiting port through which the light exits to the light guide plate may be smaller than a height in the first direction at a light incident port through which the light is incident from the band-pass filter.

A bent portion may be formed in the first portion of the sub-light guide plate to guide the specific-band light transmitted through the band-pass filter from the second portion to the lateral surface of the light guide plate. A reflecting tape may be provided in the bent portion, the reflecting tape configured to reflect the light radiated to an outside of the sub-light guide plate in the bent portion so as to guide the light to the lateral surface of the light guide plate.

In the second portion, the height in the first direction, which is the thickness direction of the light guide plate, of a connection portion between the second portion and the first portion may be smaller than the height in the first direction at the light incident port through which the light is incident from the band-pass filter.

The liquid crystal display device may further include a circuit board on which a driving circuit that drives the display panel is mounted. The second portion of the sub-light guide plate may include a higher portion which is high in the first direction and a lower portion in which a height in the first direction is smaller than that of the higher portion. The circuit board may be disposed on a rear surface side of the lower portion of the sub-light guide plate.

The liquid crystal display device may further include a circuit board on which a driving circuit that drives the display panel is mounted. The height in the first direction at the light incident port is a first height. The second portion of the sub-light guide plate may include a slope in which the height in the first direction is inclined from the first height to a second height smaller than the first height, and a flat plate having the constant second height. The circuit board may be disposed so as to overlap the flat plate of the sub-light guide plate in planar view.

The above general aspect may include one or more of the following features. A liquid crystal display device including a light source that emits light having a predetermined color, a band-pass filter that transmits specific-band light having a specific-band wavelength in the light emitted from the light source, a light guide plate disposed on a rear surface side of a display panel, and a wavelength converter that receives the light reflected by the band-pass filter in the light emitted from the light source and converts a wavelength of the received reflected light into the specific-band wavelength.

In the present disclosure, the color reproducibility in the liquid crystal display device can be improved.

### BRIEF DESCRIPTION OF THE DRAWINGS

FIG. 1 is an exploded perspective view schematically illustrating an entire configuration of liquid crystal display device according to a first exemplary embodiment;

FIG. 2 is a plan view illustrating a configuration of backlight unit according to the first exemplary embodiment;

FIG. 3 is a sectional view taken along line A-A in FIG. 2;

FIG. 4 is a graph illustrating a transmission spectral characteristic of band-pass filter;

FIG. 5 is a plan view illustrating a configuration of backlight unit according to a second exemplary embodiment;

FIG. 6 is a sectional view taken along line B-B in FIG. 5;

FIG. 7 is a plan view illustrating a configuration of backlight unit according to a third exemplary embodiment;

FIG. 8 is a view illustrating a first example of backlight unit according to the third exemplary embodiment;

FIG. 9 is a sectional view taken along line C-C in FIG. 7;

FIG. 10 is a view illustrating a second example of backlight unit according to the third exemplary embodiment;

FIG. 11 is a sectional view illustrating liquid crystal display device in which backlight unit of the third example in FIG. 10 is used;

FIG. 12 is a plan view illustrating a configuration of backlight unit according to the fourth exemplary embodiment; and

FIG. 13 is a sectional view taken along line D-D in FIG. 12.

### DETAILED DESCRIPTION

An embodiment of the present application is described below with reference to the drawings. The embodiment of the present application takes a liquid crystal display device as an example of a display device of the present application. However, the present application is not limited thereto.

### First Exemplary Embodiment

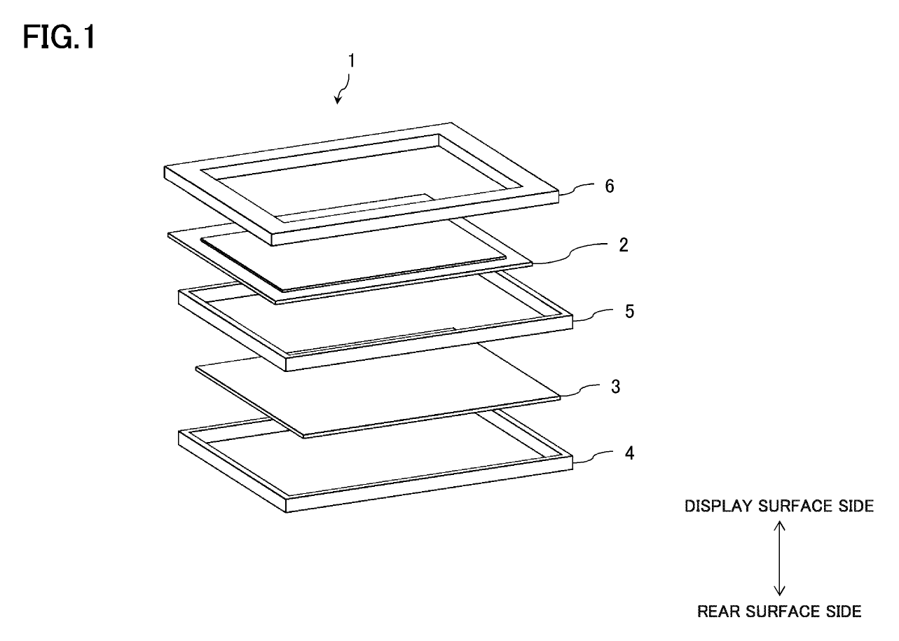

FIG. 1 is an exploded perspective view schematically illustrating an entire configuration of liquid crystal display device 1 according to a first exemplary embodiment. Liquid crystal display device 1 includes display panel 2 that displays an image and backlight unit 3 that irradiates display panel 2 from a rear surface side. Liquid crystal display device 1 is assembled such that display panel 2 is sandwiched between upper frame 6 and intermediate frame 5 and backlight unit 3 is sandwiched between intermediate frame 5 and lower frame 4.

Although not illustrated, display panel 2 includes a TFT substrate, a counter substrate, and a liquid crystal layer sandwiched between the TFT substrate and the counter substrate. A driver IC that drives display panel 2 is provided in the TFT substrate. Known configurations can be applied to the TFT substrate and the counter substrate.

Backlight unit 3 is disposed on the rear surface side of display panel 2. Backlight unit 3 will be described later.

Lower frame 4 is disposed on the rear surface side of backlight unit 3 to support backlight unit 3.

Intermediate frame 5 is formed into a rectangular shape when viewed from a display surface side, and has a substantially L-shaped cross-section. Intermediate frame 5 is disposed on the rear surface side of display panel 2 to cover a peripheral portion of display panel 2.

Upper frame 6 is formed into a rectangular shape when viewed from the display surface side, and has a substantially L-shaped cross-section. Upper frame 6 is disposed on the surface side of display panel 2 to cover the peripheral portion of display panel 2.

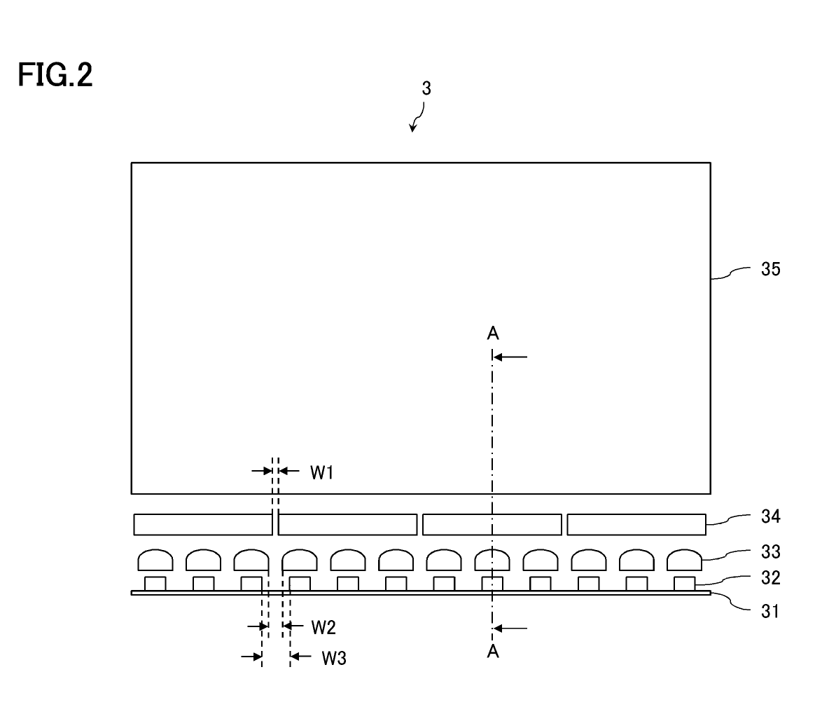

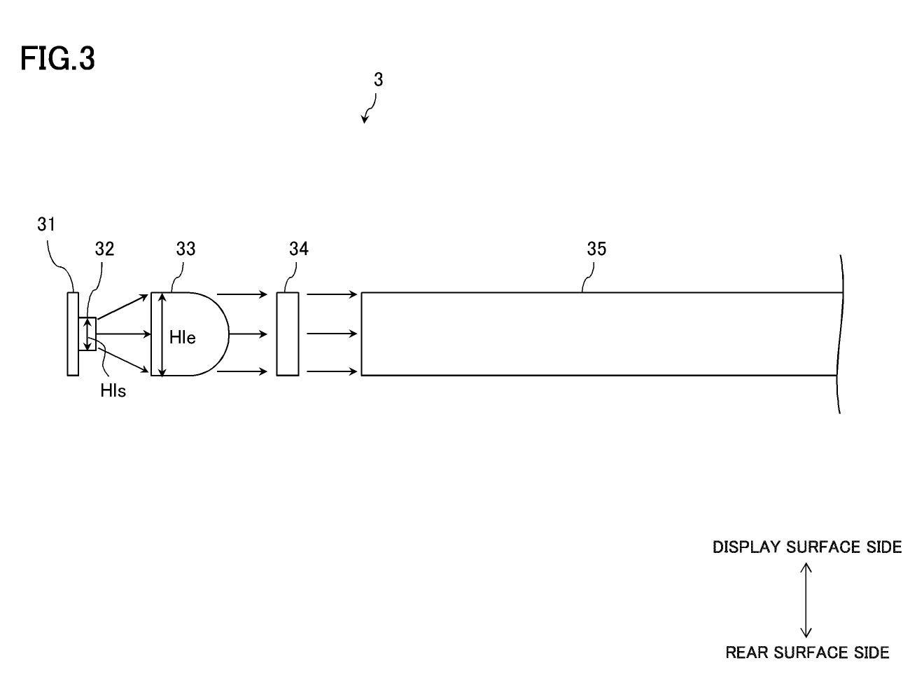

FIG. 2 is a plan view illustrating a configuration of backlight unit 3 according to the first exemplary embodiment. FIG. 3 is a sectional view taken along line A-A′ in FIG. 2. Backlight unit 3 according to the first exemplary embodiment includes light source 32, lens 33, band-pass filter 34, and light guide plate 35.

Light source 32 is a point-like light source that emits light having a predetermined color. For example, light source 32 emits red light having center wavelengths of 620 nm to 650 nm, green light having center wavelengths of 520 nm to 540 nm, and blue light having center wavelengths of 450 nm to 470 nm. For example, light source 32 can be configured by a plurality of LEDs. Light source 32 may be a spontaneous light emitter such as a red LED, a green LED, and a blue LED, or have a structure in which the blue LED and a phosphor or quantum dots (QD) are combined to emit the light having a predetermined color. A plurality of light sources 32 are disposed on a lateral surface side of light guide plate 35 mounted on substrate 31, and the light emitted from light source 32 is incident on one lateral surface of light guide plate 35 through surface lens 33 and band-pass filter 34. Although FIG. 2 illustrates an example in which the plurality of light sources 32 are disposed in one lateral surface of light guide plate 35, the plurality of light sources 32 may be disposed in both lateral surfaces of light guide plate 35.

Lens 33 is disposed on a light emission surface side of light source 32, and concentrates the light emitted from light source 32, and the light is incident on band-pass filter 34. Because the light emitted from light source 32 diverges radially, lens 33 concentrates the light such that the light is vertically incident on band-pass filter 34. For example, the plurality of light sources 32 and a plurality of lenses 33 are disposed in a one-to-one manner. Height Hle in a first direction, which is a thickness direction of light guide plate 35, of lens 33 is greater than height Hls in the first direction of height light source 32.

Band-pass filter 34 is disposed on a light exiting surface side of lens 33 to transmit light having a specific-band wavelength (hereinafter, referred to as specific-band light) in the light exiting from lens 33, and the specific-band light is incident on the lateral surface of light guide plate 35. Band-pass filter 34 is configured by a glass substrate and a dielectric lamination film deposited on the glass substrate, and the desired specific-band light is transmitted through band-pass filter 34 in accordance with a number of layers or a film thickness of the dielectric lamination film. Because band-pass filter 34 has the incident angle dependency, the light is desirably vertically incident on band-pass filter 34 in order to obtain a desired filter effect (band-pass filter 34 transmits the desired specific-band light). In the first exemplary embodiment, an amount of light vertically incident on band-pass filter 34 is increased with lens 33, which improves the filter effect of band-pass filter 34.

One band-pass filter 34 may be disposed for the plurality of lenses 33, and a plurality of band-pass filters 34 may be disposed for the plurality of lenses 33. For example, 6 band-pass filters 34 are disposed for 48 lenses 33, where one band-pass filter 34 corresponds to 8 lenses 33. In the example of FIG. 2, 4 band-pass filters 34 are disposed for 12 lenses 33, where one band-pass filter 34 corresponds to 3 lenses 33. In the case where the plurality of band-pass filters 34 are disposed, each light source 32, each lens 33, and each band-pass filter 34 are disposed such that light source 32 and lens 33 do not overlap a gap between adjacent band-pass filters 34 when viewed from the lateral surface side of light guide plate 35. Specifically, each light source 32, each lens 33, and each band-pass filter 34 are disposed such that distance W1 of the gap between adjacent band-pass filters 34 is smaller than distance W2 of the gap between adjacent lenses 33 and distance W3 of the gap between adjacent light sources 32, and such that a center line of the gap between adjacent band-pass filters 34, a center line of the gap between adjacent lenses 33, and a center line of the gap between adjacent light sources 32 coincide with one another. Therefore, an amount of light incident on the lateral surface of light guide plate 35 through the gap between adjacent band-pass filters 34 can be reduced, and a loss of filter effect due to the gap between band-pass filters 34 when the plurality of band-pass filters 34 are disposed can be reduced.

The specific-band light transmitted through band-pass filter 34 exits uniformly from a display surface side of light guide plate 35, whereby light guide plate 35 causes backlight unit 3 to serve as a surface light source. A reflecting sheet (not illustrated) is disposed on the rear surface side of light guide plate 35 such that the specific-band light incident on light guide plate 35 does not exit from surfaces other than the display surface side of light guide plate 35. An optical sheet (not illustrated) is disposed on the display surface side of light guide plate 35. The optical sheet concentrates the light exiting from light guide plate 35, and guides the light onto the rear surface side of display panel 2. The optical sheet may include a diffusion sheet that diffuses and homogenizes the light exiting from light guide plate 35.

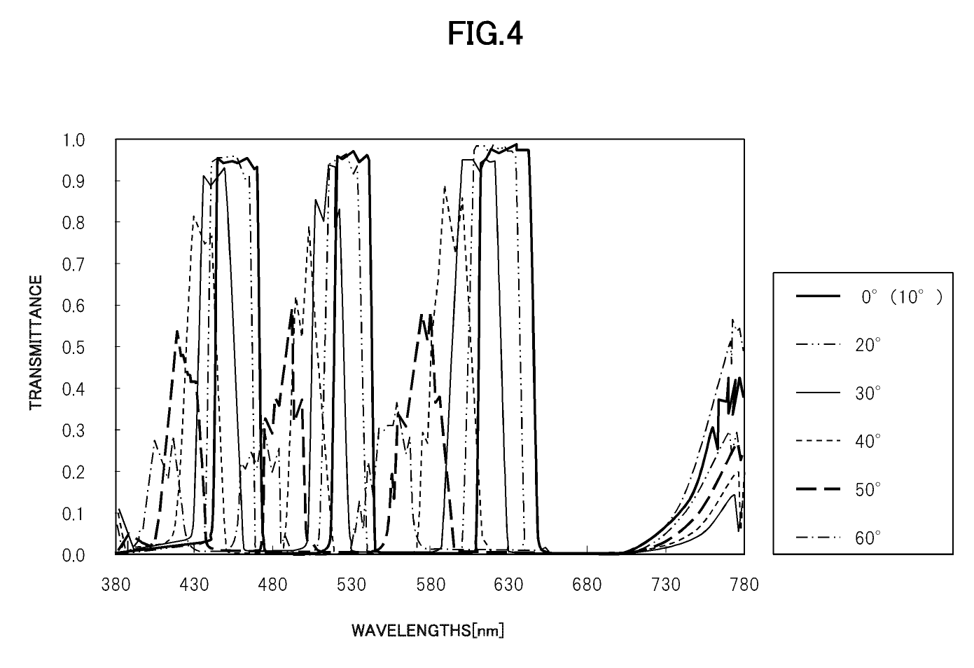

An example of specific configurations of lens 33 and band-pass filter 34 will be described below. FIG. 4 is a graph illustrating a transmission spectral characteristic of band-pass filter 34. The incident angle dependency (a relationship between a wavelength and a transmittance with respect to an incident angle of the light incident on band-pass filter 34) of band-pass filter 34 is illustrated in the graph of FIG. 4. FIG. 4 illustrates the transmission spectral characteristic of band-pass filter 34 when the incident angle of the light incident on band-pass filter 34 is set to 0°, 10°, 20°, 30°, 40°, 50°, and 60°. The incident angles of 0° and 10° are substantially equal to each other in the transmission spectral characteristic of band-pass filter 34. As illustrated in FIG. 4, a wavelength region of the light transmitted through band-pass filter 34 and the transmittance of band-pass filter 34 decreases with increasing incident angle of the light incident on band-pass filter 34. Particularly, when the incident angle of the light incident on band-pass filter 34 is larger than 20°, the incident angle dependency of band-pass filter 34 changes to a non-negligible extent. Therefore, in the first exemplary embodiment, lens 33 is designed such that the incident angle of the light incident on band-pass filter 34 is less than or equal to 20°. Band-pass filter 34 is designed so as to transmit the light having the wavelength regions of 460 nm to 465 nm, 525 nm to 535 nm, and 630 nm to 640 nm for the incident angle of 0°.

In the first exemplary embodiment, light source 32, lens 33, and band-pass filter 34 are disposed in the lateral surface of light guide plate 35, which allows the color reproducibility of liquid crystal display device 1 to be improved with small-sized band-pass filter 34.

### Second Exemplary Embodiment

In the first exemplary embodiment, because the thickness of light guide plate 35 is determined according to height Hle in the first direction of lens 33, the thickness of light guide plate 35 tends to increase. Therefore, in a second exemplary embodiment, the thickness of light guide plate 35 is reduced so as to meet a low profile of liquid crystal display device 1. A configuration of liquid crystal display device 1 of the second exemplary embodiment will be described in detail below.

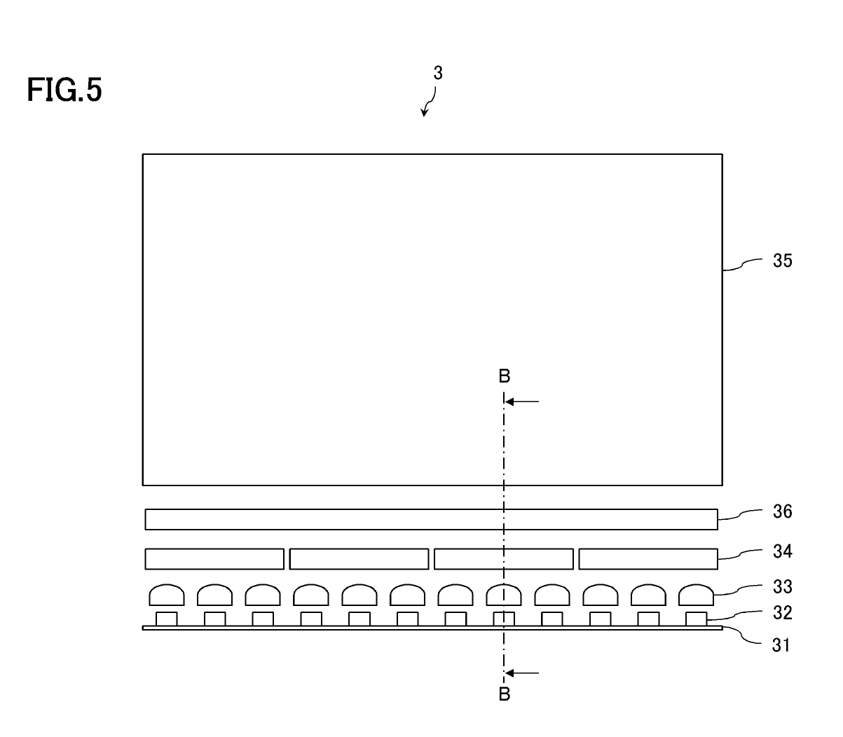

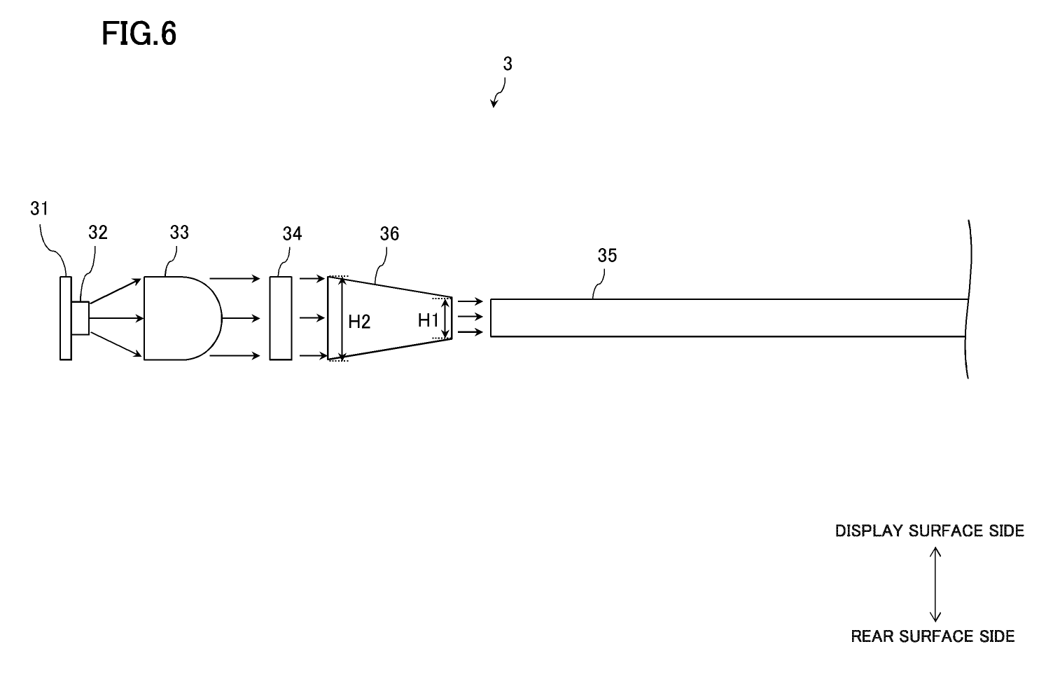

FIG. 5 is a plan view illustrating a configuration of backlight unit 3 according to the second exemplary embodiment. FIG. 6 is a sectional view taken along line B-B′ in FIG. 5. Backlight unit 3 according to the second exemplary embodiment includes light source 32, lens 33, band-pass filter 34, light guide plate 35, and sub-light guide plate 36. Backlight unit 3 according to the second exemplary embodiment differs from backlight unit 3 of the first exemplary embodiment only in the configuration of sub-light guide plate 36. Accordingly, in the second exemplary embodiment, the configuration similar to that of the first exemplary embodiment is designated by the same reference numeral, and the overlapping description is omitted.

In the second exemplary embodiment, light source 32, lens 33, band-pass filter 34, and sub-light guide plate 36 are disposed on a lateral surface side of light guide plate 35. Sub-light guide plate 36 is disposed between band-pass filter 34 and light guide plate 35.

Sub-light guide plate 36 causes the specific-band light exiting from band-pass filter 34 to be incident on the lateral surface of light guide plate 35. In sub-light guide plate 36, height H1 in the first direction, which is the thickness direction of light guide plate 35, at a light exiting port through which the light exits to light guide plate 35, is smaller than height H2 in the first direction at a light incident port through which the light is incident from band-pass filter 34. Specifically, for example, sub-light guide plate 36 is formed into a trapezoidal shape in cross-section as illustrated in FIG. 6. The shape of sub-light guide plate 36 is not limited to the example in FIG. 6. It is only necessary to form sub-light guide plate 36 into a shape in which height H1 in the first direction of light guide plate 35 at the light exiting port through which the light exits to light guide plate 35 is smaller than height H2 in the first direction at the light incident port through which the light is incident from band-pass filter 34. Therefore, the thickness of light guide plate 35 can be determined according to height H1 in the first direction of the light exiting port of sub-light guide plate 36, and the thickness of light guide plate 35 according to the second exemplary embodiment can be made smaller than the thickness of light guide plate 35 according to the first exemplary embodiment.

In the second exemplary embodiment, the use of sub-light guide plate 36 can reduce the thickness of light guide plate 35, and deal with the low-profile of liquid crystal display device 1. Additionally, in the second exemplary embodiment, an optical path length is lengthened, so that the light can be homogenized to suppress unevenness of the light source.

### Third Exemplary Embodiment

In the first exemplary embodiment, because light source 32, lens 33, and band-pass filter 34 are disposed on the lateral surface side of light guide plate 35, a frame region of liquid crystal display device 1 tends to increase. Therefore, in a third exemplary embodiment, light source 32, lens 33, and band-pass filter 34 are disposed on the rear surface side of light guide plate 35 so as to deal with a narrower frame of liquid crystal display device 1. A configuration of liquid crystal display device 1 according to the third exemplary embodiment will be described in detail below.

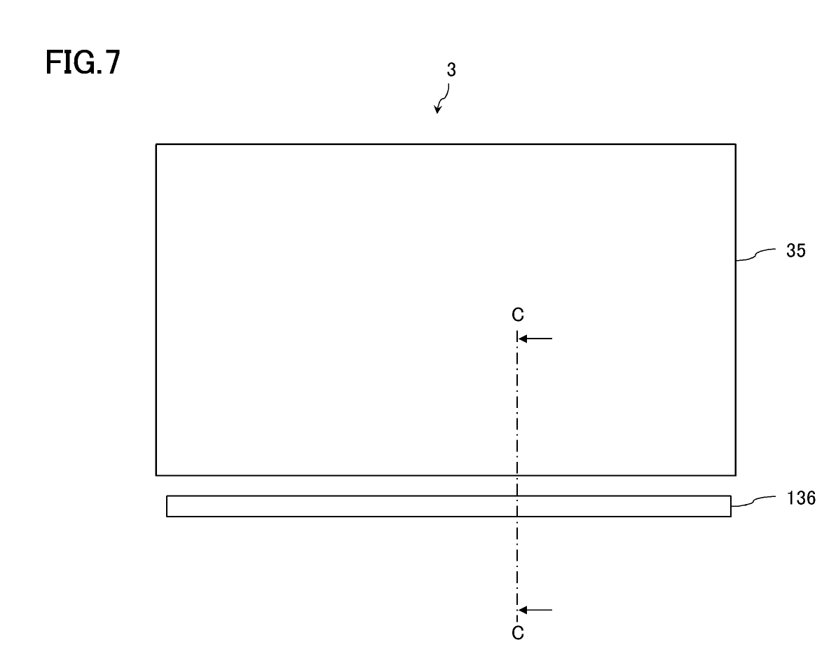

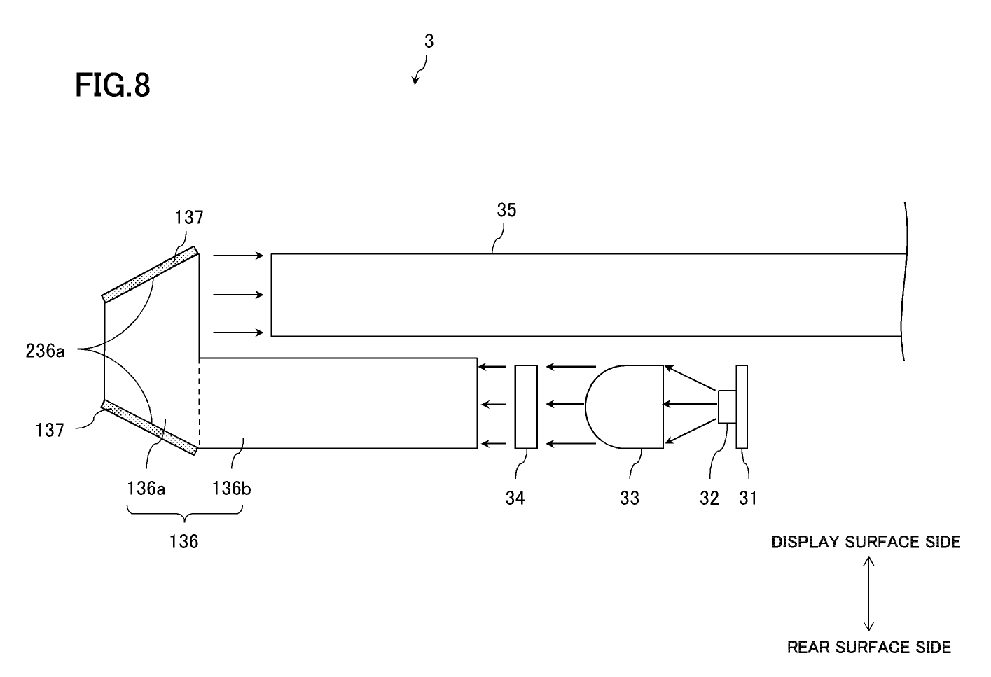

FIG. 7 is a plan view illustrating a configuration of backlight unit 3 according to the third exemplary embodiment. FIG. 8 is a view illustrating a first example of backlight unit 3 according to the third exemplary embodiment. FIG. 8 is a sectional view taken along line C-C in FIG. 7. Backlight unit 3 according to the third exemplary embodiment includes light source 32, lens 33, band-pass filter 34, light guide plate 35, and sub-light guide plate 136. Backlight unit 3 according to the third exemplary embodiment differs from backlight unit 3 according to the first exemplary embodiment only in the positions of light source 32, lens 33, and band-pass filter 34 and the configuration of sub-light guide plate 36. Accordingly, in the third exemplary embodiment, the configuration similar to that of the first exemplary embodiment is designated by the same reference numeral, and the overlapping description is omitted.

In the third exemplary embodiment, light source 32, lens 33, and band-pass filter 34 are disposed on the rear surface side of light guide plate 35. Sub-light guide plate 136 is disposed on the rear surface side and the lateral surface side of light guide plate 35. Sub-light guide plate 136 is disposed to guide the specific-band light transmitted through band-pass filter 34 to light guide plate 35.

Sub-light guide plate 136 causes the specific-band light exiting from band-pass filter 34 to be incident on the lateral surface of light guide plate 35. Sub-light guide plate 136 includes first portion 136a located on the lateral surface side of light guide plate 35 and second portion 136b located on the rear surface side of light guide plate 35. In other words, sub-light guide plate 136 is formed to have a substantially L-shaped cross-section by first portion 136a and second portion 136b. The shape of sub-light guide plate 136 is not limited to the L-shape. For example, sub-light guide plate 136 may have a U-shape. The specific-band light exiting from band-pass filter 34 is incident on second portion 136b of sub-light guide plate 136, and exits from first portion 136a to the lateral surface of light guide plate 35 through second portion 136b and first portion 136a.

Bent portion 236a is formed in first portion 136a of sub-light guide plate 136 to guide the specific-band light transmitted through band-pass filter 34 from second portion 136b to the lateral surface of light guide plate 35. For example, bent portion 236a is bent by an angle of 45 degrees with respect to a lateral end (incident surface) of surface light guide plate 35. At this point, the light incident on sub-light guide plate 136 is partially radiated to the outside of sub-light guide plate 136 in bent portion 236a, which may cause leakage of light. For this reason, reflecting tape 137 is provided in bent portion 236a. Reflecting tape 137 reflects the light radiated to the outside of sub-light guide plate 136 in bent portion 236a so as to guide the light to the lateral surface of light guide plate 35. For example, reflecting tape 137 is formed by a silver evaporated film. When reflecting tape 137 is provided in bent portion 236a, leakage of light is suppressed in sub-light guide plate 136, which allows the improvement of light use efficiency.

In the first example of the third exemplary embodiment, light source 32, lens 33, and band-pass filter 34 are disposed on the rear surface side of light guide plate 35, and sub-light guide plate 136 causes the specific-band light exiting from band-pass filter 34 to be incident on the lateral surface of light guide plate 35, which allows the narrower frame of liquid crystal display device 1 to be dealt with. Additionally, in the third exemplary embodiment, the optical path length is lengthened, so that the light can be homogenized to suppress the unevenness of the light source.

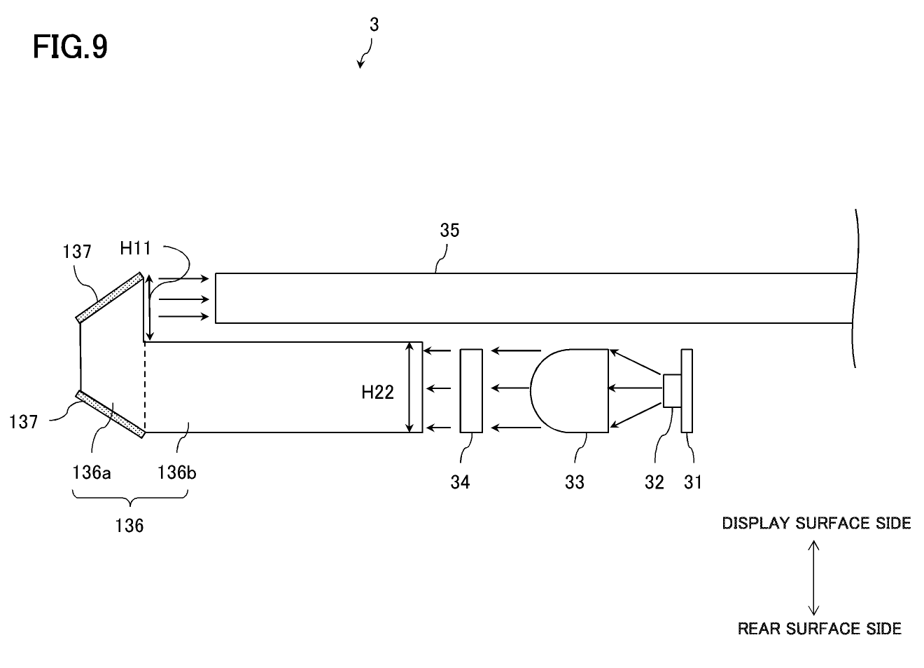

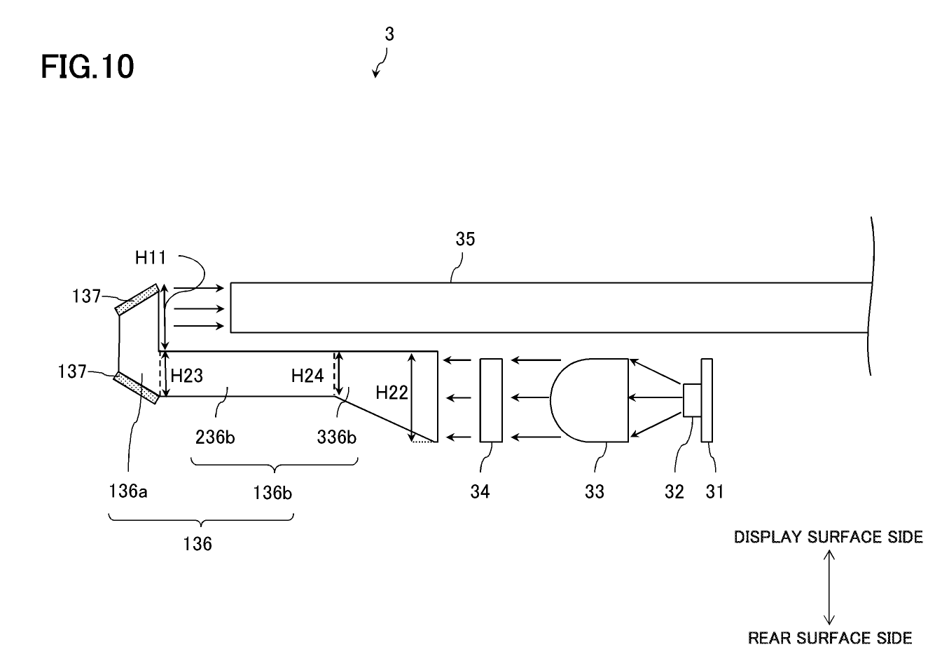

FIG. 9 is a view illustrating a second example of backlight unit 3 according to the third exemplary embodiment. FIG. 10 is a sectional view taken along line C-C in FIG. 7. As illustrated in FIG. 9, in sub-light guide plate 136, height H11 in the first direction of light guide plate 35 at the light exiting port through which the light exits to light guide plate 35 is smaller than height H22 in the first direction at the light incident port through which the light is incident from band-pass filter 34. Therefore, the thickness of light guide plate 35 can be determined according to height H11 in the first direction of the light exiting port of sub-light guide plate 36, and the thickness of light guide plate 35 in the second example according to the third exemplary embodiment can be made smaller than the thickness of light guide plate 35 in the first example according to the first exemplary embodiment.

In the second example of the third exemplary embodiment, the narrower frame of liquid crystal display device 1 can be dealt with, and the low-profile of liquid crystal display device 1 can also be dealt with.

FIG. 10 is a view illustrating a third example of backlight unit 3 according to the third exemplary embodiment. FIG. 10 is a sectional view taken along line C-C in FIG. 7. As illustrated in FIG. 10, in second portion 136b of sub-light guide plate 136, height H23 in the first direction of a connection portion between second portion 136b and first portion 136a is smaller than height H22 in the first direction of the light incident port through which the light is incident from band-pass filter 34. As illustrated in FIG. 10, second portion 136b of sub-light guide plate 136 includes higher portion 336b which is high in the first direction and lower portion 236b in which the height in the first direction is smaller than that of higher portion 336b. For example, higher portion 336b constitutes a slope that is inclined from first height H22 in the first direction of the light incident port to second height H24 smaller than first height H22 in a range from the light incident port through which the light is incident from band-pass filter 34 to a connection portion between higher portion 336b and lower portion 236b. Lower portion 236b constitutes a flat plate in which the height in the first direction is constant second height H24 in a range from a connection portion between lower portion 236b and higher portion 336b to a connection portion between lower portion 236b and first portion 136a. Referring to FIG. 10, second height H24 is equal to height H23 in the first direction of the connection portion between lower portion 236b and first portion 136a. In other words, in second portion 136b of sub-light guide plate 136, a recess is formed toward the display surface side by lower portion 236b and higher portion 336b. In FIG. 10, height H11 in the first direction of light guide plate 35 at the light exiting port of sub-light guide plate 136 is smaller than height H22 in the first direction at the light incident port of sub-light guide plate 136. Thus, the recess is formed toward the display surface side in second portion 136b of sub-light guide plate 136, which allows the circuit board and the like to be disposed in the recess.

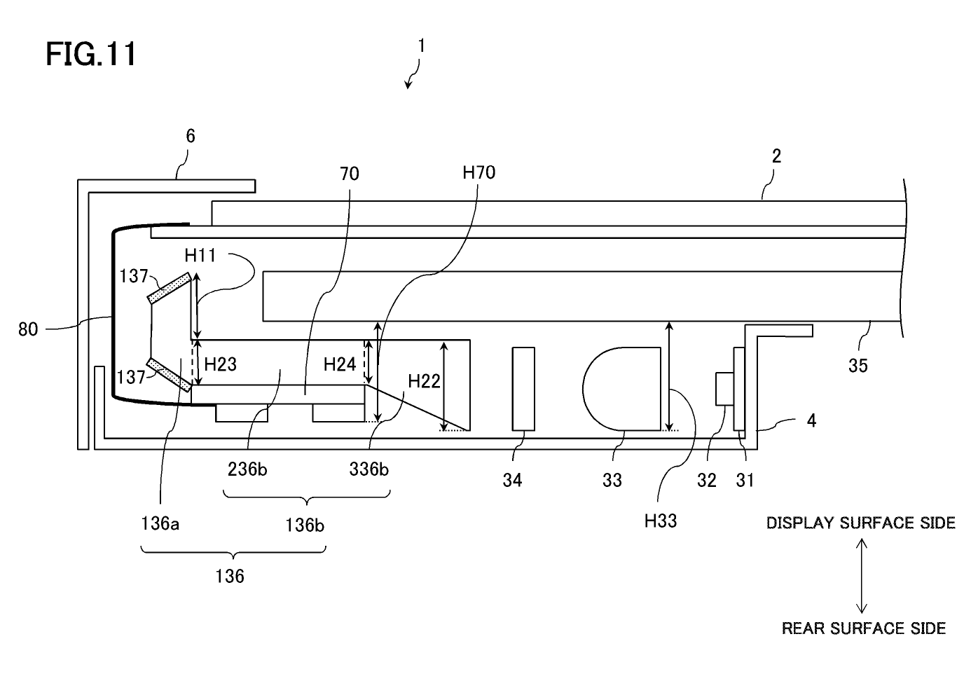

FIG. 11 is a sectional view illustrating liquid crystal display device 1 in which backlight unit 3 of the third example in FIG. 10 is used. Backlight unit 3 in FIG. 11 is a cross-section taken along line C-C in FIG. 7. As illustrated in FIG. 11, liquid crystal display device 1 is assembled such that display panel 2, backlight unit 3, circuit board 70, and FPC 80 are sandwiched between upper frame 6 and lower frame 4.

A driving circuit (such as a source driver and a gate driver) that drives display panel 2 is mounted on circuit board 70. FPC 80 electrically connects the peripheral portion of display panel 2 and circuit board 70.

Circuit board 70 is disposed on the rear surface side of sub-light guide plate 136. Specifically, circuit board 70 is disposed on the rear surface side of lower portion 236b in second portion 136b of sub-light guide plate 136 so as to overlap lower portion 236b in second portion 136b of sub-light guide plate 136 in planar view. At this point, a portion located closest to the rear surface side in circuit board 70 is located closer to the display surface side than a portion located closest to the rear surface side among lens 33, band-pass filter 34, and sub-light guide plate 136. For example, in the case where a portion positioned closest to the rear surface side among lens 33, band-pass filter 34, and sub-light guide plate 136 is the surface on the rear surface side of lens 33, height 1170 from the surface on the rear surface side of light guide plate 35 to the surface on the rear surface side of the circuit board is smaller than height 1133 from the surface on the rear surface side of light guide plate 35 to the surface on the rear surface side of lens 33 as illustrated in FIG. 11.

In the third example of the third exemplary embodiment, the narrower frame of liquid crystal display device 1 can be dealt with, and the thickness of liquid crystal display device 1 can be reduced than that in the second example of the third exemplary embodiment.

### Fourth Exemplary Embodiment

Band-pass filter 34 reflects light having a band other than a specific band in which light is transmitted through band-pass filter 34. The light reflected by band-pass filter 34 is absorbed by surrounding members, and the light use efficiency degrades. Therefore, in a configuration of a fourth exemplary embodiment, the light reflected by band-pass filter 34 is reused to improve the light use efficiency. A configuration of liquid crystal display device 1 according to the fourth exemplary embodiment will be described in detail below.

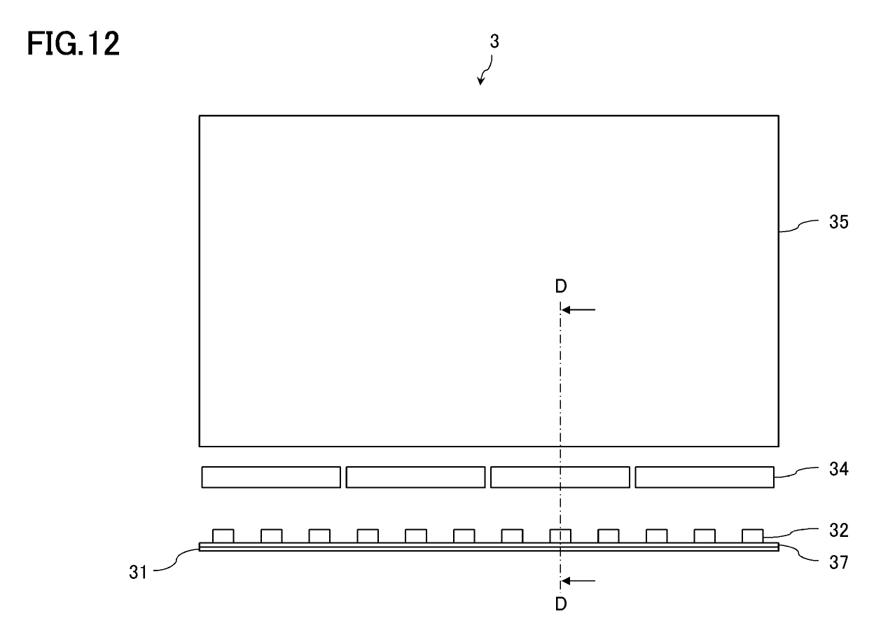

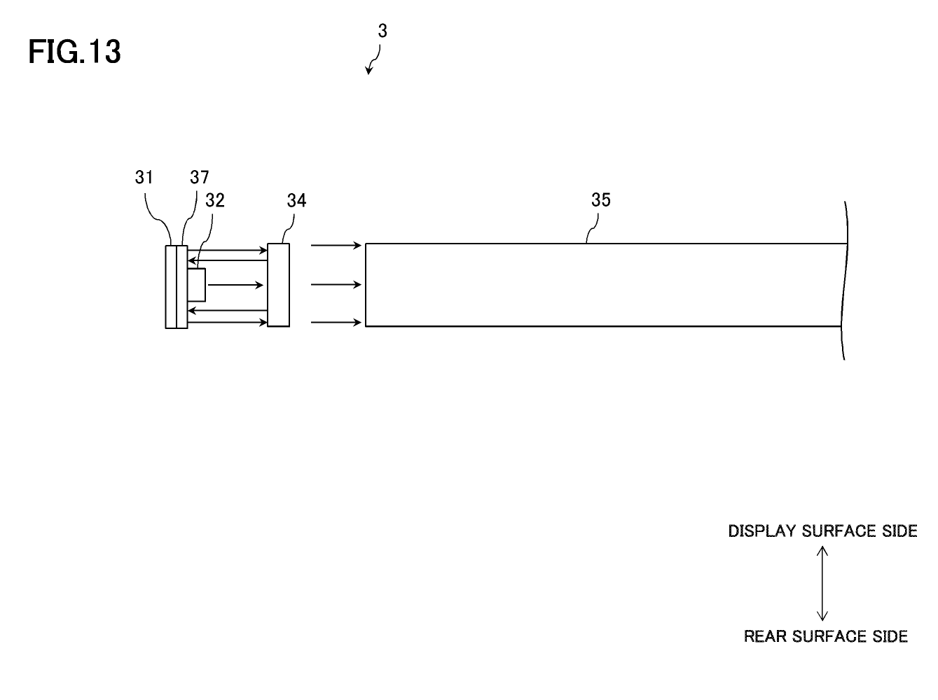

FIG. 12 is a plan view illustrating a configuration of backlight unit 3 according to the fourth exemplary embodiment. FIG. 13 is a sectional view taken along line D-D in FIG. 12. Backlight unit 3 according to the fourth exemplary embodiment includes light source 32, band-pass filter 34, light guide plate 35, and wavelength converter 37. In the fourth exemplary embodiment, the configuration similar to that of the first exemplary embodiment is designated by the same reference numeral, and the overlapping description is omitted.

In the fourth exemplary embodiment, light source 32, band-pass filter 34, and wavelength converter 37 are disposed on the lateral surface side of light guide plate 35.

The light exiting from light source 32 is incident on one lateral surface of light guide plate 35 through band-pass filter 34.

Band-pass filter 34 is disposed on the light exiting surface side of light source 32 to transmit the specific-band light having the specific-band wavelength in the light exiting from light source 32, and the specific-band light is incident on the lateral surface of light guide plate 35.

Wavelength converter 37 is disposed on the light source 32 side with respect to band-pass filter 34. For example, wavelength converter 37 is disposed in the surface of substrate 31 and around light source 32. Wavelength converter 37 receives the light reflected by band-pass filter 34 in the light emitted from light source 32, converts the wavelength of the received reflected light into the specific-band wavelength, and outputs the reflected light having the specific-band wavelength to band-pass filter 34. The phosphor or quantum dots (QD) can be used as wavelength converter 37.

In the fourth exemplary embodiment, the light use efficiency can be improved in liquid crystal display device 1 in which band-pass filter 34 is used.

What is claimed is:

1. A liquid crystal display device comprising:
a light source that emits light having a predetermined color;
a lens that concentrates the light emitted from the light source and causes the light to exit;
a band-pass filter that transmits specific-band light having a specific-band wavelength in the light exiting from the lens; and
a light guide plate disposed on a rear surface side of a display panel,
wherein the specific-band light transmitted through the band-pass filter is incident on a lateral surface of the light guide plate.

2. The liquid crystal display device according to claim 1, wherein
the light source, the lens, and the band-pass filter are disposed on a lateral surface side of the light guide plate,
the liquid crystal display device further comprises a sub-light guide plate disposed between the band-pass filter and the light guide plate, and
in the sub-light guide plate, a height in a first direction, which is a thickness direction of the light guide plate, at a light exiting port through which the light exits to the light guide plate is smaller than a height in the first direction at a light incident port through which the light is incident from the band-pass filter.

3. The liquid crystal display device according to claim 1, wherein
the light source, the lens, and the band-pass filter are disposed on a rear surface side of the light guide plate,
the liquid crystal display device further comprises a sub-light guide plate that guides the specific-band light transmitted through the band-pass filter to the light guide plate, and
the sub-light guide plate includes a first portion located on a lateral surface side of the light guide plate and a second portion that is connected to the first portion and located on the rear surface side of the light guide plate.

4. The liquid crystal display device according to claim 3, wherein in the sub-light guide plate, a height in a first direction, which is a thickness direction of the light guide plate, at a light exiting port through which the light exits to the light guide plate is smaller than a height in the first direction at a light incident port through which the light is incident from the band-pass filter.

5. The liquid crystal display device according to claim 3, wherein
a bent portion is formed in the first portion of the sub-light guide plate to guide the specific-band light transmitted through the band-pass filter from the second portion to the lateral surface of the light guide plate, and
a reflecting tape is provided in the bent portion, the reflecting tape configured to reflect the light radiated to an outside of the sub-light guide plate in the bent portion so as to guide the light to the lateral surface of the light guide plate.

6. The liquid crystal display device according to claim 3, wherein in the second portion, the height in the first direction, which is the thickness direction of the light guide plate, of a connection portion between the second portion and the first portion is smaller than the height in the first direction at the light incident port through which the light is incident from the band-pass filter.

7. The liquid crystal display device according to claim 6, further comprising a circuit board on which a driving circuit that drives the display panel is mounted,
wherein the second portion of the sub-light guide plate includes a higher portion which is high in the first direction and a lower portion in which a height in the first direction is smaller than that of the higher portion, and
the circuit board is disposed on a rear surface side of the lower portion of the sub-light guide plate.

8. The liquid crystal display device according to claim 6, further comprising a circuit board on which a driving circuit that drives the display panel is mounted,
wherein the height in the first direction at the light incident port is a first height,
the second portion of the sub-light guide plate includes a slope in which the height in the first direction is inclined from the first height to a second height smaller than the first height, and a flat plate having the constant second height, and
the circuit board is disposed so as to overlap the flat plate of the sub-light guide plate in planar view.

9. A liquid crystal display device comprising:
a light source that emits light having a predetermined color;
a band-pass filter that transmits specific-band light having a specific-band wavelength in the light emitted from the light source;
a light guide plate disposed on a rear surface side of a display panel, and
a wavelength converter that receives the light reflected by the band-pass filter in the light emitted from the light source and converts a wavelength of the received reflected light into the specific-band wavelength.
